(19) United States
(12) Patent Application Publication
(10) Pub. No.: US 2021/0192778 A1
(43) Pub. Date: Jun. 24, 2021

(54) ROBUST RETROREFLECTIVE PHOTOGRAMMETRY MARKERS

(71) Applicant: FARO Technologies, Inc., Lake Mary, FL (US)

(72) Inventors: Rolf Heidemann, Stuttgart (DE); Matthias Wolke, Korntal-Münchingen (DE); Alexander Abramow, Waiblingen (DE)

(21) Appl. No.: 17/083,892

(22) Filed: Oct. 29, 2020

Related U.S. Application Data
(60) Provisional application No. 62/952,700, filed on Dec. 23, 2019.

(51) Int. Cl. G06T 7/73; G06T 7/60; G01B 11/26; G01C 11/00

(52) U.S. Cl. CPC G06T 7/73; G06T 7/60; G06T 2207/10012; G01C 11/00; G01B 11/26

(57) ABSTRACT

A retroreflective marker assembly. The assembly includes a retroreflective marker and a protective window through which light passes to reflect from the marker. A support structure supports the marker on its face and includes one or more legs, each having a facet that polarizes light upon reflection from the facet. The assembly can include a spherical base with a reflective coating secured to the base. An angular position of the marker with respect to an imaging device is determined by measuring a first angle of a light between the marker and the imaging device along a deviated optical path, determining an angular deviation of the light from a straight-line path, and determining a second angle indicative of the straight-line path based on the first angle and the angular deviation. A polarization angle of light reflected from a facet determines an orientation of the marker with respect to the imaging device.

### CROSS REFERENCE TO RELATED APPLICATIONS

The present application is a nonprovisional application of, and claims priority to, U.S. Provisional Application Ser. No. 62/952,700 filed on Dec. 23, 2019, the contents of which are incorporated by reference herein.

### FIELD OF THE INVENTION

The subject invention relates to photogrammetry markers and, in particular, to a retroreflective photogrammetry marker suitable for use in harsh environments and their method of use.

### BACKGROUND

Photogrammetry is the art, science and technology of obtaining reliable information about physical objects and the environment through the process of recording, measuring and interpreting photographic images and patterns of electromagnetic radiant imagery and other phenomena. Accurate photogrammetry typically includes retroreflective markers placed within a scene that is to be imaged, thereby marking various locations or positions within the image. Retroreflective surfaces however can be imprecise and can be damaged by wear. Further, in some environments, such as a manufacturing environment where the retroreflective markers are used on robot grippers for example, abrasive cleaning agents such as dry ice blasting may be used on a frequent basis. The use of the abrasive cleaning agents can damage or remove the retroreflective markers.

Accordingly, while existing retroreflective markers are suitable for their intended purpose there is a need to provide a more robust retroreflective marker that is capable of operating in harsh environments.

### SUMMARY OF THE INVENTION

In one exemplary embodiment of the invention, a method of determining an angular position of a retroreflective marker with respect to an imaging device is provided. The method includes: measuring a first angle at the imaging device of a light projected between the retroreflective marker and the imaging device along a deviated optical path, determining, at a processor, an angular deviation of the light from a straight-line path between the retroreflective marker and the imaging device, and determining, at the processor, a second angle at the imaging device, the second angle indicative of the straight-line path based on the first angle and the angular deviation.

In another exemplary embodiment of the invention, a retroreflective marker assembly is provided. The retroreflective marker assembly includes a retroreflective marker and a protective window, wherein light passes through the protective window to reflect from the retroreflective marker.

In yet another exemplary embodiment of the invention, a retroreflective marker assembly is provided. The retroreflective marker assembly includes a spherical base with a reflective coating and a mechanical element securing the reflective coating to the spherical base.

In yet another exemplary embodiment of the invention, a method of determining a parameter of object is provided. The method includes: placing a retroreflective marker assembly on a surface of the object, the retroreflective marker assembly comprising a support structure including one or more legs, each leg having a facet configured to polarize light upon reflection of the light from the facet, and a retroreflective marker located on a face of the support structure; obtaining a polarization angle of light reflected from a facet at an imaging device; determining an orientation of the retroreflective marker assembly with respect to the imaging device from the polarization of the light; and determining the parameter of the surface from the determined orientation of the retroreflective marker assembly.

In yet another exemplary embodiment of the invention, a retroreflective marker assembly is provided. The retroreflective marker assembly includes: a support structure including one or more legs, each leg having a facet configured to polarize light upon reflection of the light from the facet; and a retroreflective marker located on a face of the support structure.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1A shows a frontal view of an imaging device of an embodiment;

FIG. 1B shows a top view of a first camera and a second camera of the imaging device of FIG. 1A;

FIG. 2 shows an imaging configuration in which the imaging device of FIG. 1A obtains information from an object;

FIG. 3 shows a marker assembly suitable for placing a retroreflective marker on a surface of an object for the purposes of photogrammetry;

FIG. 4 shows a diagram of the media of the marker assembly of FIG. 3;

FIG. 5 shows the media of FIG. 4, illustrating an angular deviation of the position of retroreflective marker due to a presence of a protective window;

FIG. 6 shows a plot of angular deviation of light due to a presence of a protective window;

FIG. 7 shows a flowchart for determining a correction of a marker location based on a deviation of light occurring at the protective window;

FIG. 8 shows a marker assembly in an alternate embodiment.

FIG. 9 shows a cylindrical marker assembly in side view and plan view;

FIG. 10 shows a spherical marker assembly;

FIG. 11 shows a flowchart illustrating a method of manufacturing the spherical marker assembly of FIG. 10;

FIG. 12 show a flowchart illustrating a method of photogrammetry to determine three-dimensional position and orientation of a marker assembly of FIG. 3 using stereo images;

FIG. 13 shows a stereo image pair of a plurality of markers disposed within a scene;

FIG. 14 shows a processed image based on a left side image of FIG. 13;

FIG. 15 shows a left side image and a right-side image showing three-dimensional coordinates calculated from two-dimensional positions determined in stereoscopic images;

FIG. 16 shows a stereoscopic imaging setup;

FIG. 17 shows a polarization enhanced photogrammetric marker assembly;

FIG. 18 shows the marker assembly of FIG. 17 as viewed via several cameras;

FIG. 19 shows the polarization enhanced photogrammetric marker assembly; and,

FIG. 20 shows various alternative three-dimensional markers that can be used in various embodiments.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features.

Embodiments of the present invention provide advantages in use of robust retroreflective marker assemblies in photogrammetry. Methods are disclosed for correcting angular location of a retroreflective marker due to a presence of a protective window that deviates an optical path of light traveling from the retroreflective marker to an imaging device. In addition, novel structures for retroreflective marker assemblies are discussed as well as their use. In particular, a three-dimensional marker assembly is disclosed that employs facets which have an impact on the polarization of light reflected from them. The polarized light can be used to determine various parameters, such as orientation of the marker assembly with respect to an imaging device.

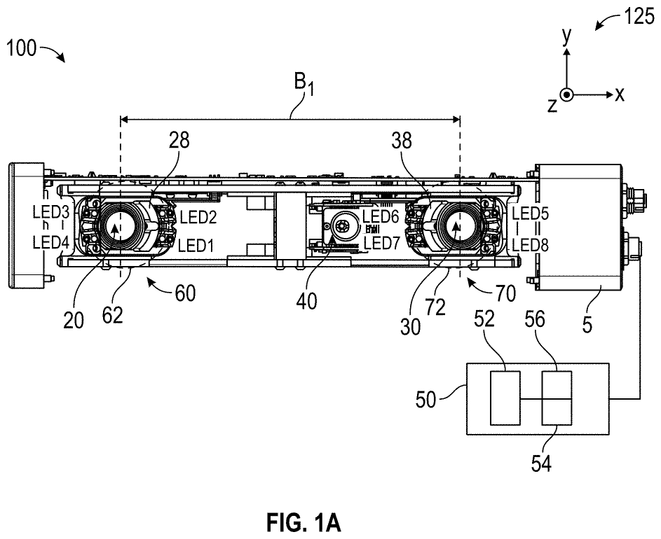

FIG. 1A shows a frontal view of an imaging device 100 of the present invention in an embodiment, also referred to as a DMVS. In various embodiments, the imaging device 100 can be a triangulation scanner. The imaging device 100 includes a body 5, a first camera 20 and a second camera 30. The imaging device 100 can further include a projector 40 for projecting structured light patterns into a region. The first camera 20 and second camera 30 are separated by a baseline having a separation distance B1. A coordinate system 125 for the imaging device 100 is shown of illustrative purposes. The baseline is parallel to an x-axis of a coordinate system 125 of the imaging device 100.

FIG. 1B shows a top view of the first camera 20 and the second camera 30 of the imaging device 100 of FIG. 1A. As shown in FIG. 1B, a first-camera optical axis 22 of the first camera 20, and a second-camera optical axis 32 of the second camera 30 lie on a common plane (i.e., plane x-z). The first-camera optical axis 22 and the second-camera optical axis 32 are generally unaligned with the z-axis of the imaging device 100. In some embodiments, an optical axis 105 of the imaging device 100 passes through a center of symmetry of the imaging device 100, for example. The first camera 20 includes a first-camera body 24 and a first-camera lens 26. The first camera 20 further includes a photosensitive array and camera electronics (not shown). The second camera 30 includes a second-camera body 34 and a second-camera lens 36. The second camera 30 further includes a photosensitive array, and camera electronics (not shown).

Referring back to FIG. 1A, the imaging device 100 includes a control unit 50. The control unit includes a processor 52 and a memory storage device 54 having programs 56 stored therein that when accessed by the processor 52 enable the processor to perform various operations for controlling operations of the imaging device 100 and its components as well as for image processing of various images captured at least one of the first camera 20 and the second camera 30. Such image processing includes position and orientation determination for the various markers and marker assembly disclosed herein. The control unit 50 can further control operation of the projector 40 and can determine 3D coordinates of points projected onto an object by the projector 40. The control unit 50 can be included inside the body 5 or may be external to the body 5. In further embodiments, more than one processor can be used. In an embodiment, the imaging device 100 may determine the 3D coordinates in a similar manner to that described in commonly owned U.S. Patent Application 2017/0186183, which is incorporated by reference herein.

The imaging device 100 further includes a stereo illumination system that includes a first set 60 of light sources associated with the first camera 20 and a second set 70 of light sources associated with the second camera 30. The light sources of the first set 60 and the light sources of the second set 70 can be light-emitting diodes in various embodiments. In various embodiments, the first set 60 of light sources is a single light source and the second set 70 of light sources is a single light source. In various embodiments, the first set 60 of light sources is a single ring of light, such as a ring of light-emitting diodes (LEDs), or LED right of light, and/or the second set 70 of light sources is a single LED ring of light, such as an LED ring of light. The first set 60 of light sources are located along a periphery or ring 62 that is concentric with a central or optical axis of the first camera 20. In other words, each of the light sources in the first set 60 is located at the same position radially outward from the central axis of first camera 20. Similarly, the second set 70 of light sources are located along a periphery or ring 72 concentric with a central axis of the second camera 30. Each light source is oriented to project light rays along selected directions. In various embodiments, the orientation of the light rays are non-parallel to the z-axis of the coordinate system 125. In one embodiment, the first set 60 of light sources includes four light sources (LED 1, LED 2, LED 3, LED 4) and the second set 70 of light sources includes four light sources (LED 5, LED 6, LED 7, LED 8). In alternate embodiments, each of the first set 60 and the second set 70 includes at least two light sources.

The light sources are coupled to the control unit 50. The control unit 50 can control the times at which the light sources are turned on and off as well as the illumination levels of each light source. In various embodiments, the control unit operates the first set 60 of light sources separately or independently from the second set 70 of light sources, for example, to control stereo and /or mono lighting of a region.

As shown in FIG. 1A, the first set 60 of light sources associated with the first camera 20 are labelled LED 1, LED 2, LED 3, and LED 4. LED 1 is located in a bottom right corner of the first camera 20 as viewed from the frontal view (FIG. 1A) of the imaging device 100. Further in respect to the first camera 20, LED 2 is located in a top right corner, LED 3 is located in a top left corner and LED 4 is located in a bottom left corner.

The light sources of the second camera 30 are labelled LED 5, LED 6, LED 7, and LED 8. LED 5 is located in a top right corner of the second camera 30 as viewed from the frontal view of the imaging device 100. Further in respect to the second camera 30, LED 6 is located in a top left corner, LED 7 is located in a bottom left corner and LED 8 is located in a bottom right corner. The particular method of numbering the light sources shown herein are for exemplary purposes and the claims should not be so limited. It is contemplated that in other embodiments, the positions of the light sources with respect to the cameras 20, 30 may be different.

In an embodiment, the arrangement of the first set 60 of light sources is a mirror image of the arrangement of the second set 70 of light sources about the optical axis 105 (FIG. 1B). The top LEDS (i.e., LED 2, LED 3, LED 5 and LED 6) are generally a same distance above the base line and the lower LEDS (i.e., LED 1, LED 4, LED 7 and LED 8) are generally as same distance below the baseline. In other words, the LED pairs are equidistant from the baseline.

FIG. 1B shows the LEDs of the first camera 20 and second camera 30 from a top view. LED 2 and LED 3 are shown with respect to the first camera 20, whereas LED 1 and LED 4 are behind LED 2 and LED 3, respectively, and are therefore not visible in FIG. 1B. Similarly, LED 5 and LED 6 are shown with respect to the second camera 30, whereas LED 8 and LED 7 are behind LED 5 and LED 6, respectively, and are therefore not visible in FIG. 1B.

It should be appreciated that while embodiments herein describe the use of a retroreflective marker with the device 100, this is for exemplary purposes and the claims should not be so limited. In other embodiments, the retroreflective marker that is described herein may be used with other photogrammetry systems, such as not limited to a single camera system, a stereoscopic camera system, or a system with a plurality of cameras.

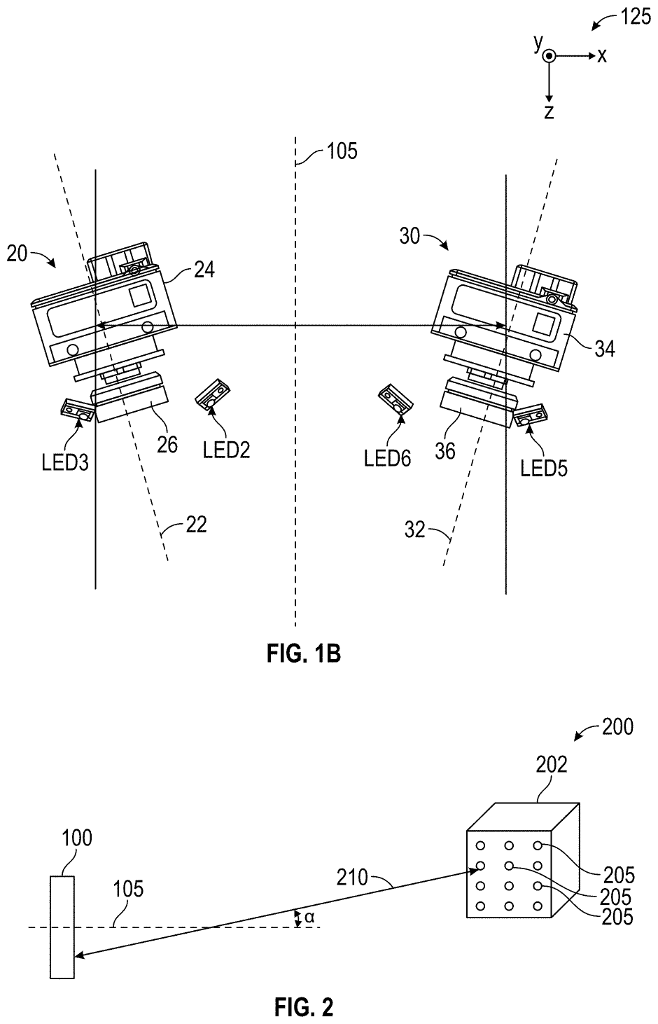

FIG. 2 shows an imaging configuration 200 in which the imaging device 100 of FIG. 1 obtains information from an object 202. The object 202 includes a plurality of retroreflective marker 205 placed thereon. The imaging device 100 is located at a selected distance d from the object 202 and at an orientation with respect to the optical axis 105 of the imaging device 100, as indicated by angle a between a light ray 210 and the optical axis 105.

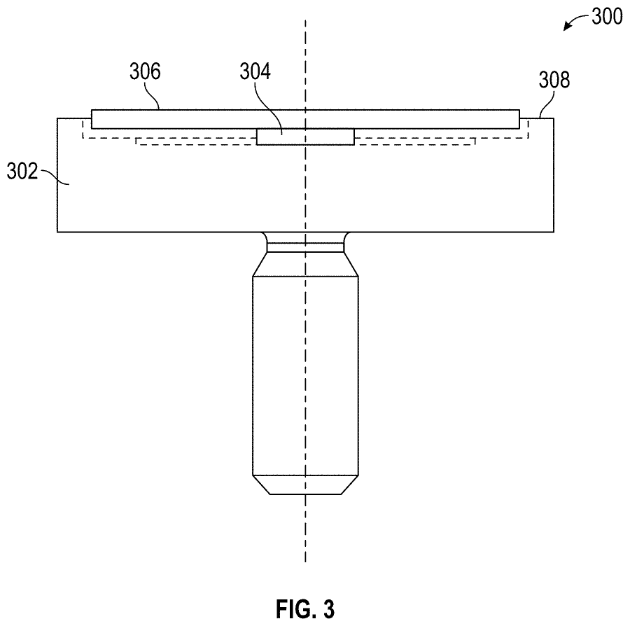

In accordance with an embodiment, FIG. 3 shows a marker assembly 300 suitable for placing a retroreflective marker, such as the retroreflective marker 205 of FIG. 2, on a surface of the object 202 for the purposes of photogrammetry. The marker assembly 300 includes a base 302 having a top surface or viewing surface 308 on which a retroreflective marker 304 is disposed. In various embodiments, the retroreflective marker 304 is a circular film or material. The base 302 can have a rotationally symmetric mount that has a symmetry axis that is collinear or substantially collinear with the symmetry axis of the retroreflective marker 304. A protective window 306 is placed over the retroreflective marker 304 in order to protect the retroreflective marker 304 from environmental elements, cleaning agents (e.g. dry ice blasting) and wear. The protective window 306 can be made of a suitable transparent material, such as glass.

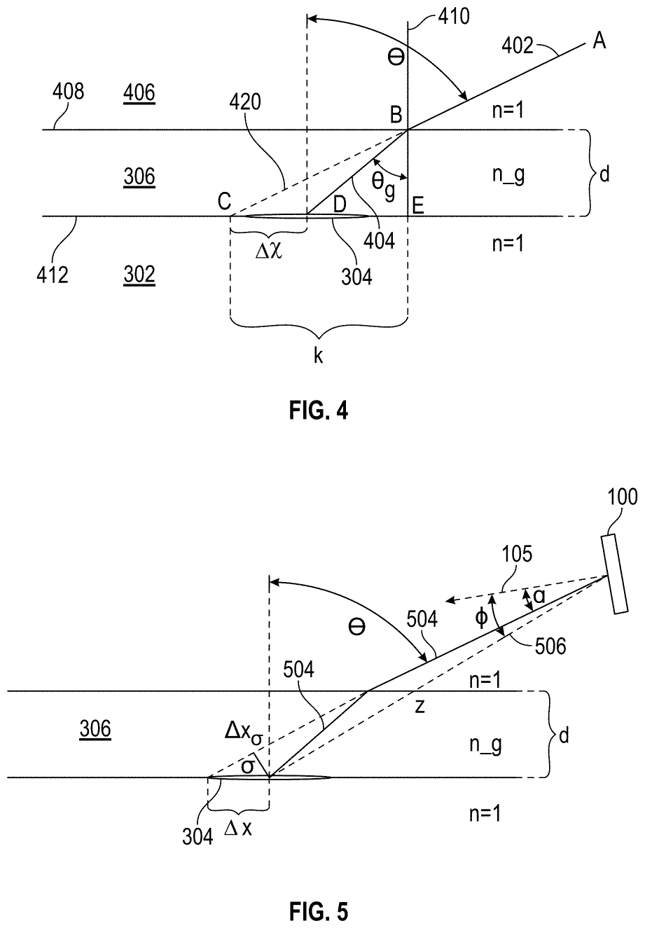

FIG. 4 shows a schematic diagram of the media of the marker assembly 300 of FIG. 3 that illustrates the effect the direction of light at the marker assembly 300. FIG. 4 illustrates a path taken by a beam of light as it passes through the protective window 306 of the marker assembly 300 of FIG. 3. The protective window 306 is shown on top of base 302 with the retroreflective marker 304 centrally located between of the protective window 306 and the base 302. For purposes of illustration, the protective window 306 is made of glass having index of refraction n_{g} and having a thickness d. The region 406 above the protective window 306 is air, having index of refraction n=1. A selected light beam 402 projected from the imaging device at location A is incident on a glass-air interface 408 of the marker assembly 300 at a location B at orientation angle θ. Line 410 is normal to the glass-air interface 408 at point B. The glass-air interface 408 is parallel to the glass-base interface 412. Therefore, the line 410 intersects the glass-base interface 412 at point E.

An undeviated extended path 420 has been illustrated in FIG. 4 that continues the path of light beam 402 through the protective window 306 from point B to point C at the glass-base interface 412. The undeviated extended path 420 travels horizontally by a distance k through the protective window 306 as it travels through the protective window 306. Light beam 402 is however refracted at point B. The refracted light 404 at point B passes through the protective window 306 at a refractive angle θ_{g} and is incident on the retroreflective marker 304 at its center D. Therefore, the refracted light 404 travels a horizontal distance k-Δx as it passes through the protective window 306 to be incident at the center of the retroreflective marker 304 at point D. Since the camera sees the retroreflective marker 304 at point C, the presence of the protective window 306 in front of the retroreflective marker 304 produces a horizontal deviation Δx in the determined position of the center of the retroreflective marker 304. This horizontal deviation Δx depends on the orientation angle θ of the retroreflective marker 304 with respect to a camera and a thickness d of the protective window 306.

The horizontal deviation Δx can be determined using in terms of the orientation angle θ and various properties of the protective window 306 as discussed with respect to Eqs. (1)-(6). Triangle BDE, which includes the path of the refracted light 404, yields the trigonometric relation of Eq. (1):

$$\frac{k - Δ x}{a} = tan {θ}_{g} \qquad Eq . ( 1 )$$

Triangle BCE, which includes the undeviated extended path 420, yields the trigonometric relation of Eq. (2):

$$\frac{k}{d} = tan θ \qquad Eq . ( 2 )$$

From Eq. (1) and Eq. (2), it follows that the horizontal deviation Δx is:

Δx=d(tan θ−tan θ_{g}) Eq. (3)

Snell's law states that:

$$sin {θ}_{g} = \frac{1}{{n}_{g}} sin θ \qquad Eq . ( 4 )$$

Therefore, Eq, (3) can be rewritten using Eq. (4) and known trigonometric identities to obtain Eq. (5):

$$Δ x = d ( tan θ - \frac{\frac{1}{{n}_{g}} sin θ}{\sqrt{1 - \frac{1}{{n}_{g}^{2}} {sin}^{2} θ}} ) = d ( tan θ - \frac{sin θ}{\sqrt{{n}_{g}^{2} - {sin}^{2} θ}} ) \qquad Eq . ( 5 )$$

For small angles, Eq. (5) reduces to:

$$Δ x \approx d ( 1 - \frac{1}{{n}_{g}^{2}} ) θ \qquad Eq . ( 6 )$$

Thus, even for small angles, the horizontal deviation Δx is significant (e.g. ˜100 μm for a 1mm glass plate with n_{g}=1.5). The horizontal deviation Δx causes a deviation in a calculated angular location of the retroreflective marker, as discussed with respect to FIG. 5.

FIG. 5 shows the media of FIG. 4, illustrating an angular deviation of the position of retroreflective marker 304 that is due to the presence of the protective window 306 for the marker assembly 300 of FIG. 3. In various embodiments, a camera, such as the imaging device 100, is used to obtain an image of the marker and determine the angular position of the retroreflective marker 304. The imaging device 100 is oriented along its optical axis 105 and detects the retroreflective marker 304 along a projected light beam 504 that forms an angle α with optical axis 105. The actual location of the retroreflective marker 304 with respect to the imaging device 100 is along straight-line path 506 between the imaging device 100 at point A and the center of the retroreflective marker 304 at point D. The straight-line path 506 has a length z and forms an angle ϕ with the optical axis 105. The angular difference between the straight-line path 506 and the projected light beam 504 is therefore the deviation angle ϕ-α.

The deviation angle ϕ-α can be estimated based on the projected distance of the traveled by the projected ray and the horizontal deviation Δx:

$$tan ( φ - α ) \approx \frac{Δ {x}_{σ}}{z} \qquad Eq . ( 7 )$$

where z is the absolute distance from the marker center D to the camera center A and

Δx_{σ}=Δx sin σ Eq. (8

is the previously estimated horizontal deviation Δx projected onto the ray of observation and σ is the angle between the projected ray of the camera and the plane of the marker, hence we have the identity:

$$σ = \frac{π}{2} - θ \qquad Eq . ( 9 )$$

with the approximation for Δx above, we get the following Eq. (10) for the orientation dependent shift in angle space:

$$tan ( φ - α ) = \frac{d}{z} ( 1 - \frac{1}{{n}_{g}^{2}} ) θ cos θ \qquad Eq . ( 10 )$$

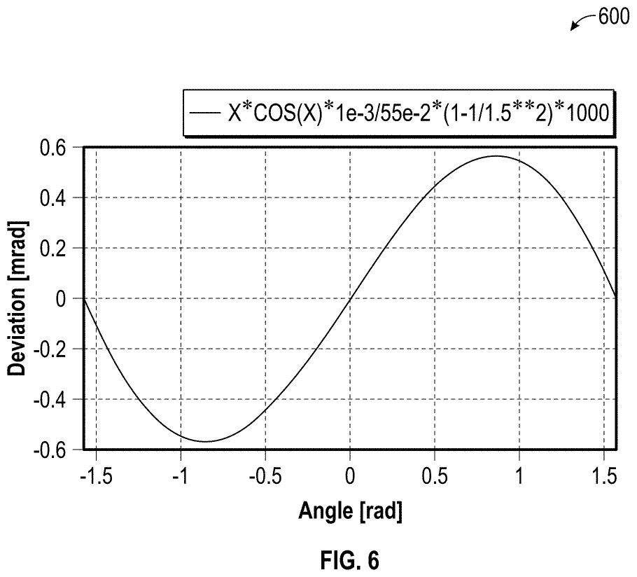

FIG. 6 shows a plot 600 of the right-hand side of Eq. (10) where the glass plate has a thickness d=1 mm and index of refraction n_{g=}1.5 and a distance between the camera and the marker is z=55 cm (i.e., a typical distance for the DMVS of FIGS. 1A-B). The curve shown in plot 600 can be used to correct for angular deviation of the image of the retroreflective marker due to the presence of the protective window 306. From Eq. (10), it is clear the angular deviation between the projected light beam 504 and the straight-line path 506 can be determined used the thickness of the glass, refractive index of the glass and a perpendicular distance between the marker and the camera is known. The thickness and refractive index are generally known from specifications and the perpendicular distance can be determined.

The DMVS imaging device 100 generally has a pixel resolution of ˜1 mrad. The photogrammetric markers are typically located with an accuracy and precision significantly below 0.5 pixel. Hence, the deviation introduced by a glass plate, i.e., protective window 306, can lead to a significant measurement error.

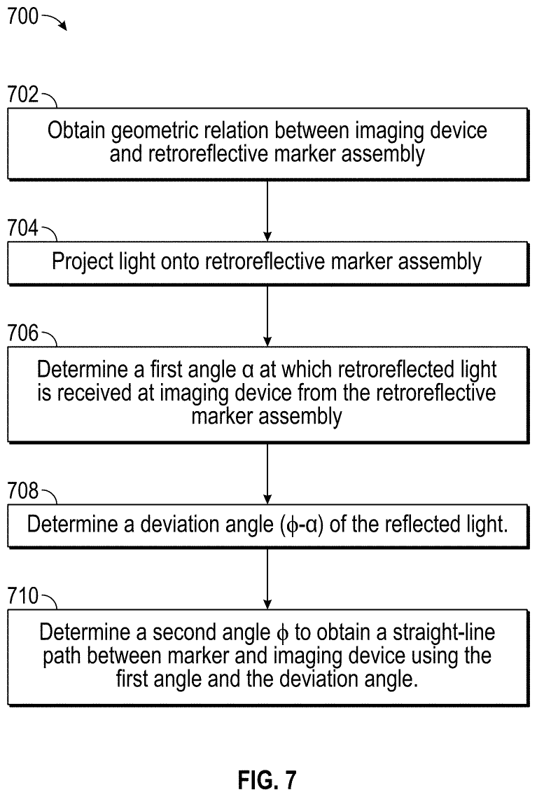

FIG. 7 shows a flowchart 700 for determining a correction of a marker location based on the deviation of light occurring at the protective window. Determining the correction includes knowing a geometrical relation between an imaging device and the marker location, such as a distance between the marker location and imaging device and a relative orientation between the marker and imaging device. This can be performed by observing the marker with from at least two locations. Either a single camera can be used to image the marker from two locations or a DMVS (or other suitable two-camera system) can be used to image the marker from a single position. In either scenario, the camera positions have a fixed or known geometric relation to each other. In box 702, a geometric relation between the imaging device and the retroreflective marker assembly is obtained. In box 704, a light beam is projected onto the retroreflective marker. In box 706, a first angle α of light beam 504 at the imaging device (i.e., with respect to the optical axis of the imaging device) is determined. The projected light beam 504 travels a deviated optical path between the retroreflective marker and the imaging device. In box 708, an angular deviation of the reflected light is determined (i.e., using Eq. (10)). In box 710, a second angle (measured at the imaging device) indicative of a straight-line path 506 between the retroreflective marker and the imaging device angle is determined from the first angle and the angular deviation.

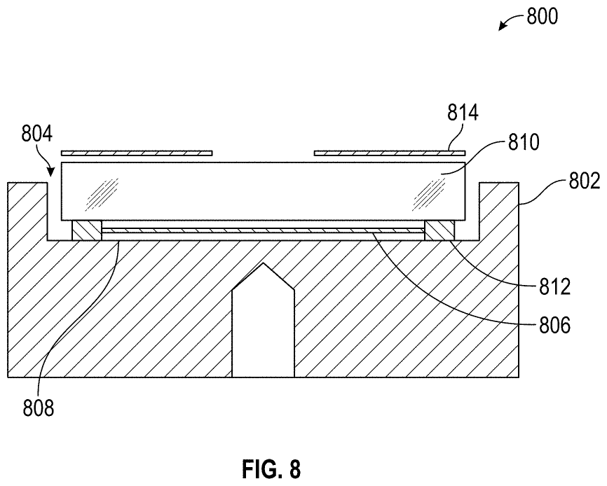

FIG. 8 shows a marker assembly 800 in accordance with an alternate embodiment. The alternate marker assembly 800 has the advantage that there is no deviation introduced to the position of the marker when it is observed under an angle. An aperture on the mask acts as the retroreflective marker. The marker assembly 800 includes a housing or base 802 including a recess 804. In various embodiments, the base 802 is made of aluminum. A retroreflective film 806 is disposed on a bottom surface 808 of the recess 804 and a glass 810 material (or other transparent material) is secured in the recess 804 to sandwich the retroreflective film 806 between the bottom surface 808 and the glass 810. The glass 810 can be secured in the recess by any suitable device including glue, double-sticky tape, etc. In an embodiment, the retroreflective film 806 includes a frame 812 that offsets the glass 810 from the bottom surface 806. A mask 814 includes an aperture through which light can pass to travel through the glass 810 and reflect off of retroreflective film 806. In one embodiment, the mask 814 on the glass 810 can be produced by masking a circular shape and coating the glass with a metal, such as by physical vapor deposition. In another embodiment, the mask 814 can be selectively deposited using a laser. In yet another embodiment, the metal can be deposited to coat the glass and an aperture can be selectively removed via a laser.

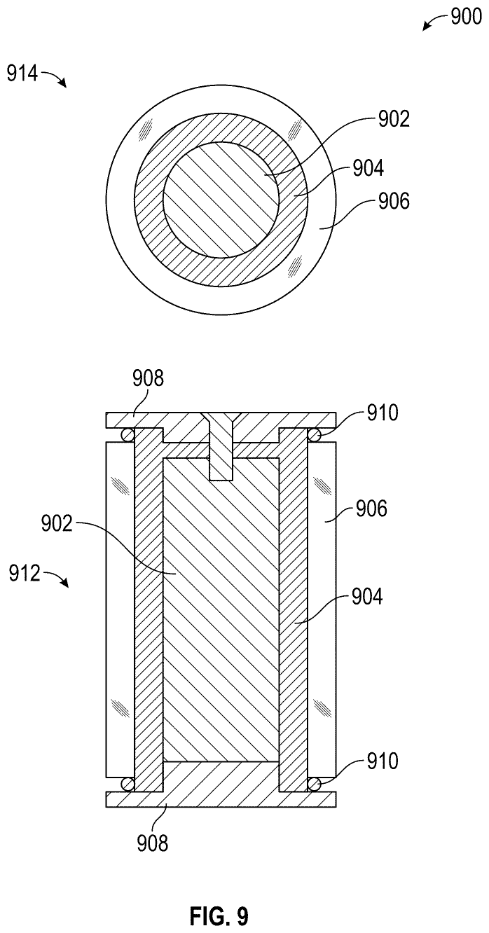

FIG. 9 shows a cylindrical retroreflective marker assembly 900 in side view 912 and plan view 914 in accordance with an embodiment. The cylindrical marker assembly 900 includes a cylindrical base 902 which can be made of aluminum, steel, or other suitable material. A reflective cylindrical film 904 made of reflective material surrounds the cylindrical base 902 and a glass cylindrical shell 906 surrounds the reflective cylindrical film 904. Caps 908 are placed at opposite ends of the cylindrical marker assembly 900 and are secured to the cylindrical base 902 in order to encapsulate the reflective cylindrical film between the cylindrical base 902 and the glass cylindrical shell 906. A sealant 910 can be used to seal any gaps between the glass cylindrical shell 906 and the caps 908.

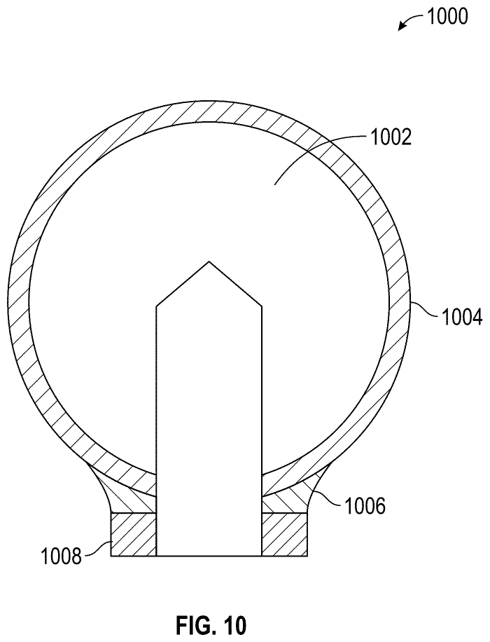

FIG. 10 shows a spherical marker assembly 1000. The spherical marker assembly 1000 includes a spherical base 1002 with a reflective coating 1004 surrounding formed on an outer surface of the spherical base 1002. An adhesive ring 1006 secures the reflective coating 1004 and the spherical base 1002 to a mounting pin 1008. The number of possible angles at which the spherical marker assembly 1000 can be viewed is directly related to a ratio between the diameter of the sphere and the diameter the mounting pin 1008.

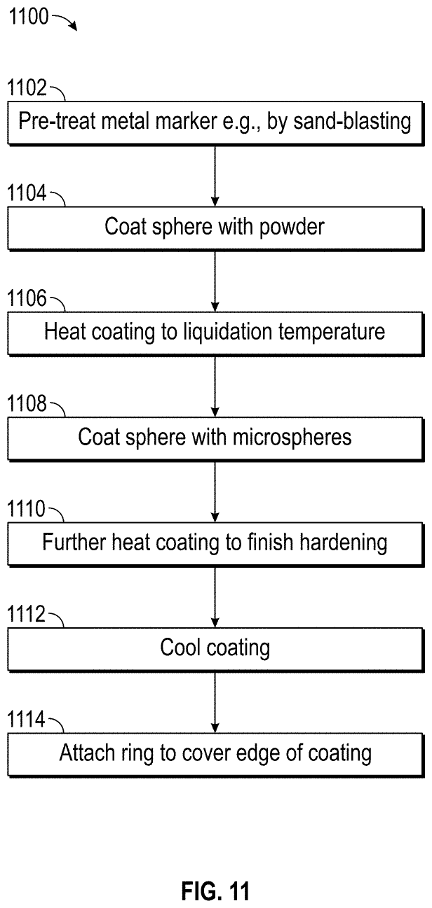

FIG. 11 shows a flowchart 1100 illustrating a method of manufacturing the spherical marker assembly 1000 of FIG. 10. In box 1102, a surface of the spherical base 1002 is pre-treated, for example, by sand blasting. In box 1104, the surface of the pre-treated spherical base 1002 is coated with a powder. In box 1106, the coating is heated to a liquidation temperature of the coating. In box 1108, the sphere is coated with glass microspheres. In one embodiment, the glass microspheres are half-covered with a metal to improve reflectance. In another embodiment, the glass microspheres are half-covered with a chemical coating on one side to help orient the microspheres so that the reflective side is oriented toward the powder-coating. In box 1110, the coating is further heated in order to complete a hardening process. In box 1112, the coating is cooled. In boxes 1114, a ring is attached to cover the edge of the coating e.g. to prevent corrosive effects on the edge.

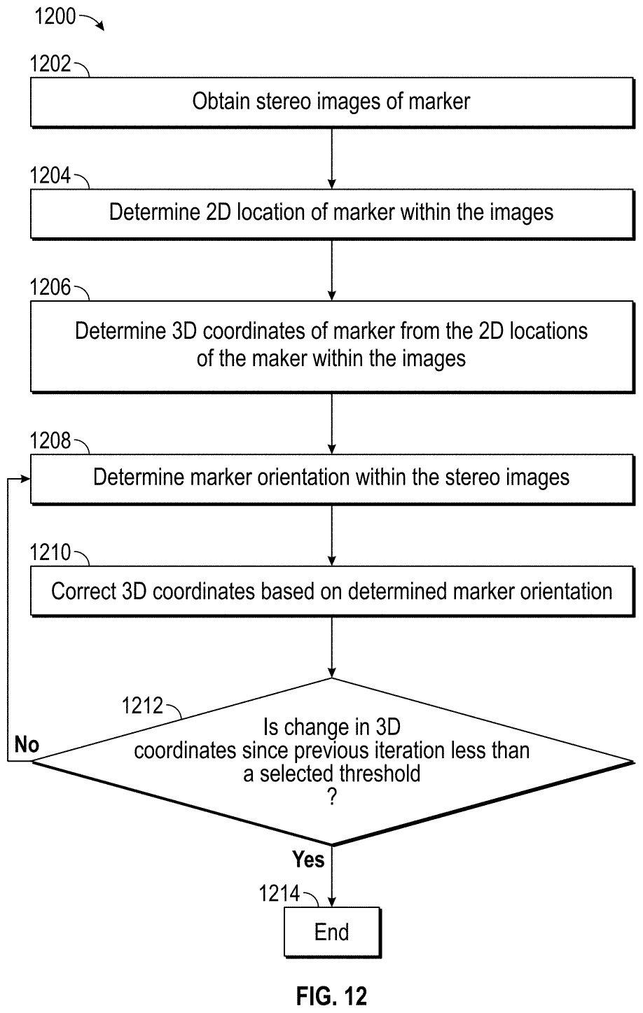

FIG. 12 show a flowchart 1200 illustrating a method of photogrammetry to determine three-dimensional position and orientation of a marker assembly 300 of FIG. 3 using stereo images such as by using the DMVS of FIG. 1. In box 1202, stereo images are obtained. In box 1204, two-dimensional positions of the marker are determined in each of the stereo images. This can include angular corrections based on Eq. (10) when a distance between the camera is known. In box 1206, three-dimensional coordinates of the marker are determined using the two-dimensional positions of the marker within the images. In box 1208, a direction or orientation of the marker is determined. The direction or orientation of the marker can be determined by measuring ellipses in the images, given that the retroreflective markers are circular in nature. In box 1210, the three-dimensional coordinates of the marker are recalculated using the orientation direction of the marker determined in box 1208. For a marker such as the marker of FIG. 3, this recalculation can be performed using the methods described herein with respect to Eqs. (1)-(10). (Recalcuation is not performed for the spherical marker of FIG. 10.) Recalculation uses the marker orientation, the distance between the camera and the marker and the observation angle in order to determine a deviation angle. Box 1212 is a decision box comparing a change in a computation of 3D coordinates in the previous iteration to a current computation of the 3D coordinates. If the change in the values of the 3D coordinates due to a single iteration is less than a selected threshold, then the calculations can come to an end at box 1214. Otherwise, the computation process is iterated by returning to box 1208 with the updated vales of angle, distance, etc.

In one embodiment, a single iteration through the loop of boxes 1208 through 1212 is enough to provide accurate location and orientation values. For applications desiring higher levels of accuracy, a second calculation loop may be used. Alternatively, the calculation may iteratively update the 3D coordinates until the value of the change for the markers falls below the selected threshold.

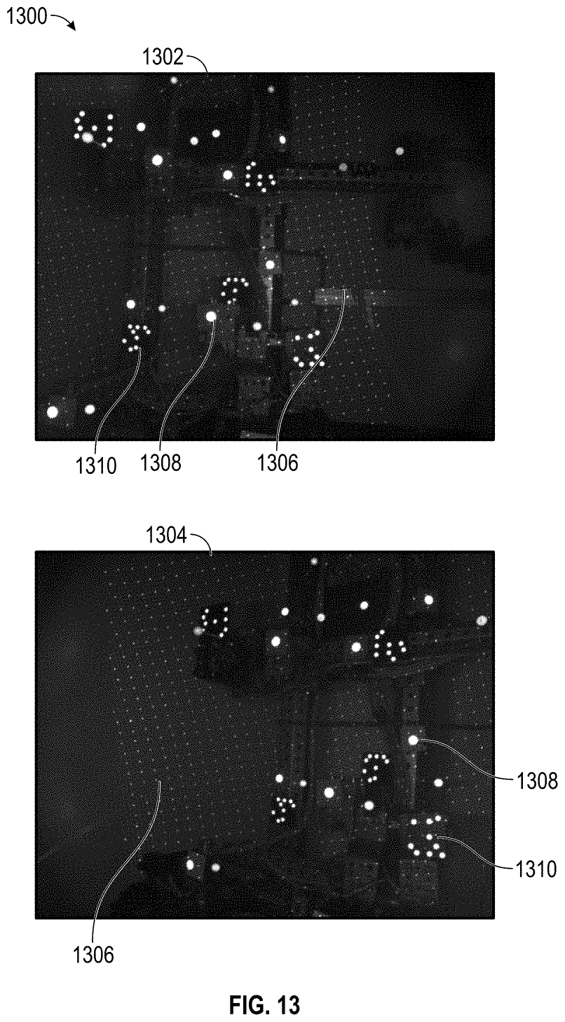

FIG. 13 shows a stereo image pair 1300 of a plurality of markers disposed within a scene. The stereo image pair 1300 includes a left side image 1302 and a right-side image 1304. The laser pattern 1306 projected from the DMVS is visible, as are several retroreflective markers 1308 and 1310. The laser pattern 1306 can be ignored when processing the retroreflective markers 1308, 1310.

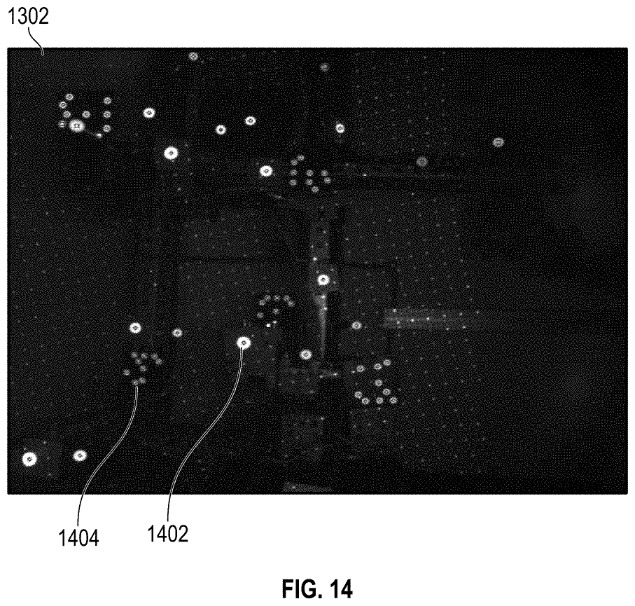

FIG. 14 shows a processed image based on the left side image 1302 of FIG. 13. The markers 1402, 1404 are identified by circles or highlights indicating that the processor recognized them as markers. The two-dimensional position of each marker 1402, 1404 can then be extracted. For a single marker, the image processing step can extract a two-dimensional position of the center of mass of the marker, a size of the marker (based on a number of illuminated pixels that marker occupies in the image plane), and an ellipticity of the image of the marker (based on a ratio of long axis vs. short axis of the image of the marker). In addition, the membership of a marker within a group of markers can be determined from a spatially coded dot assembly.

The actual two-dimensional position of the marker can be extracted taking into account compensation for the angular deviation introduced by the glass plate, using, for example, Eq. (10). Using Eq. (10) assumes knowledge of the thickness and refractive index of the glass plate, the distance between the imaging device and the marker, and the orientation of the marker with respect to the imaging device. The thickness and index of refraction of glass plate are typically known from vendor specifications, but can be also determined using other methods.

The distance between the imaging device and the marker can be determined by triangulating a three-dimensional position of the marker. The first estimation of the three-dimensional position is based on the projected light beam 504 of FIG. 5 and therefore provides an incorrect angle. Therefore, the original three-dimensional position will be off from its correct value based on this incorrect angle. Nonetheless, the difference/error is small compared to the overall distance z. Using an iterative process, the estimation of the three-dimensional distance can be improved in a stepwise fashion to within a selected criterion or resolution.

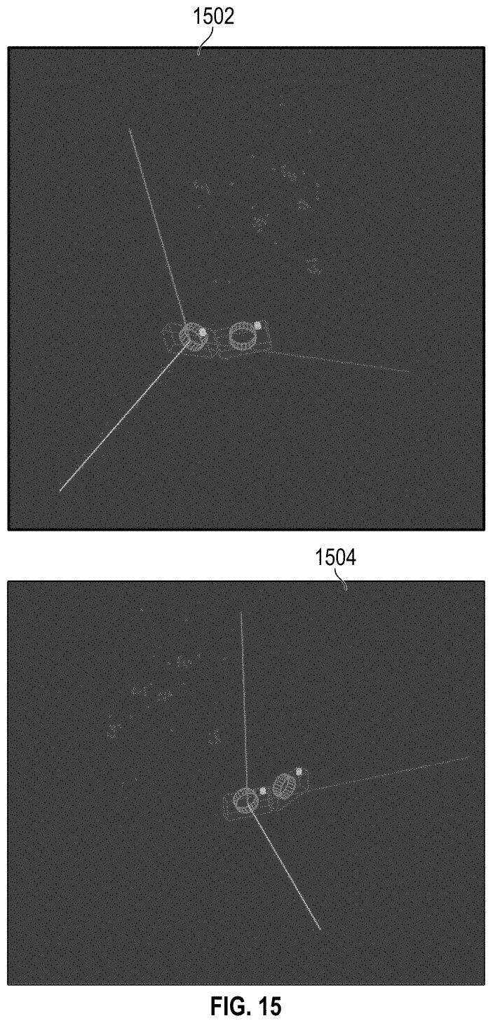

FIG. 15 shows a left side image 1502 and a right-side image 1504 showing three-dimensional coordinates calculated from the 2D positions determined in box 1204. Two images are sufficient to determine the 3D coordinates. However, more than two images in various embodiments. For a multi-camera imaging device such as the DMVS (FIG. 1), the relative camera positions are known and constant. This knowledge helps in estimating the 3D coordinates but is not necessary. Without this information, a specific scale is used to estimate the 3D coordinates. Additionally, with pre-known relative camera positions there is no need for a minimum number of markers or a specific marker alignment (i.e. at least 4 markers in non-collinear setup which ideally do not form a single plane are generally used).

The left side image 1502 and right-side image 1504 show two renderings of the 3D points. Each rendering is calculated from 2D position by triangulation. For a first iteration, the 3D coordinates can be based on 2D positions that have not had any corrections applied. Therefore, subsequent iterations can be used to correct the values of the 3D coordinates.

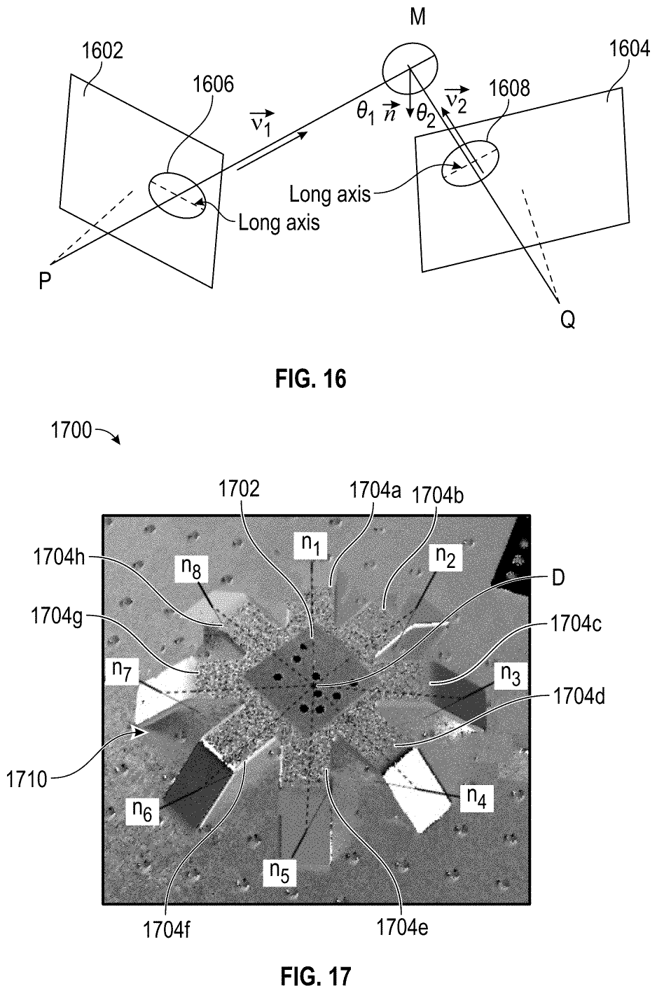

FIG. 16 shows a stereoscopic imaging setup. The imaging setup illustrates a process for determining an orientation of a marker M with respect to the cameras of the DMVS. The orientation of the marker M with respect to a selected camera (e.g., first camera P or second camera Q) can be determined based on the effects of angular orientation of the marker with respect to the imaging device on the marker's image. In various embodiments, the marker M is a circular marker. When observed at an angle, the circular marker M appears as an ellipse. A ratio of a short axis of the ellipse to a long axis of the ellipse, as well as orientation of these axes, can be used to calculate the basic orientation and an absolute value of the angle for a single marker M with respect to the selected camera. The calculations include the parameters of distance z and the angle θ. Given that the 3D coordinates are known, the distance z between the marker and the camera can be determined, because both the position of the camera and the position of the marker are known in a common coordinate system.

For a single image of a marker M, a ratio between the lengths of the long axis and short axis of a measured marker can be used to calculate the absolute value of θ, via the following equation:

$$cos θ = \frac{〈 short axis 〉}{〈 long axis 〉} \qquad Eq . ( 11 )$$

where <short axis> is a length of the short axis of the ellipse and <long axis> is a length of the long axis of the ellipse. The angle θ is shown for each camera in FIG. 12

The approximation of Eq. (11) is valid for small angular extensions of the marker and is valid for typical measurements, in which a marker is seen across ˜30×30 pixel (or less) in an image recorded with a normal lens system (i.e. no fisheye; less than ˜100 FoV). The direction of orientation can be determined along the short axis as well as an absolute value of θ. The sign of θ is however not determined. In order to obtain the sign, a second observation is taken from the second camera.

Still referring to FIG. 16, a normal vector \vec{n} to the marker M is shown. Observation vector v1 points along a direction between the marker M and a first viewing point or first camera P. Observation vector v2 points along a direction between the marker M and a second viewing point or second camera Q. The image of the circular marker M is shown to form an ellipse 1606 in the imaging plane 1602 as well as an ellipse 1608 in the imaging plane 1604.

From the estimated value of θ, the dot product of the first viewing ray with the normal vector is given by:

\vec{v₁}·\vec{n}=cos θ₁ Eq. (12)

while the dot product of the second viewing ray with the normal vector is given by

\vec{v₂}·\vec{n}=cos θ₂ Eq. (13)

where all vectors v₁, v₂ and n are normalized or unit vectors.

The direction or orientation of the marker is tilted with respect to each of the first camera P and the second camera Q. A direction perpendicular to the normal vector can be determined from the long axis of the measured ellipse and the observation vector. The long axis vector in the image plane is given by:

$$\vec{a} = ( \begin{matrix}{x}_{L} \\ {y}_{L} \\ 0\end{matrix} ) \qquad Eq . ( 14 )$$

The long axis vector can be projected into the plane perpendicular to the viewing direction (e.g., imaging planes 1602, 1604) via the following equation:

$$\vec{p} = ( \vec{{v}_{1}} \cdot \vec{a} ) \frac{\vec{{v}_{1}}}{{‖ \vec{{v}_{1}} ‖}^{2}} - \vec{a} . \qquad Eq . ( 15 )$$

The resulting dot product between the resulting vector \vec{p} and the normal vector n must be zero, i.e.,

\vec{p}·\vec{n}=0. Eq. (16)

The viewing directions \vec{v₁} and \vec{v₂} are known from the estimated or calibrated camera positions. The viewing directions are the direction vectors from their camera nodal point to the 3D position of the marker. Equations (14), (15) and (16) can therefore be determined for each camera. As a result, the system of equations for determining the normal vector of the marker is overdetermined. Therefore, for a DMVS system, the 3D information for the marker M can be determined with a single exposure. The normal vector can be determined with a least squares calculation. Once the normal vector is determined, the magnitude and sign of the angle θ can be determined for each camera of the DMVS system.

Other methods can be used in addition to the above described method for determining the orientation of a marker. In one embodiment, three or more markers can be placed on a common plane. From the distribution of the markers, it can be seen which markers belong to which assembly (e.g. all markers within a certain distance of each other will be grouped together. When the arrangement of all markers on each plane is known, the 6 degrees of freedom information of the plane can be calculated from a single image (including the distance from camera to marker). In another embodiment, the angle θ can be determined from multi-camera observations. Each observation confines the solution for the normal vector of the marker to two solutions. The estimate of angle θ is shared by at least two observations.

FIG. 17 shows a polarization enhanced photogrammetric marker assembly 1700. The enhanced marker assembly 1700 has a three-dimensional structure, with a marker 1702 located at a central disk or central portion of a three-dimensional support 1710 having a top surface and a back surface. The central portion of the three-dimensional support 1710 is also referred to herein as a viewing face. The marker 1702 is located on the top surface. The material of the support structure can be a black anodized aluminum in an embodiment. The three-dimensional support 1710 includes a plurality of legs 1704a, 1704b, 1704c, 1704d, 1704e, 1704f, 1704g, 1704h extending radially outward from a center D of the marker assembly 1700 by an equal distance and generally forming a rotationally symmetric structure. Each leg is bent or articulated at a selected radial distance from the center D by a selected angle to form a bent support section. Each support section includes a planar facet defining a normal vector (n1, . . . , n8). In the illustrative embodiment of FIG. 17, the enhanced photogrammetric marker assembly 1700 has eight legs and support sections. However, the enhanced photogrammetric marker assembly 1700 can have any number of legs and support sections in alternate embodiments.

Each facet of the support structure includes material for polarizing light upon its reflection from the facet. A polarization camera can be used to record the polarization enhanced photogrammetric marker assembly 1700. Each pixel of a polarization camera records not only an intensity distribution of light but also a polarization state of the light.

Once the polarization state is recorded for each facet of the legs 1704a-h, the polarization state of each facet can be used to calculate the orientation and/or rotation of the marker assembly 1700 with respect to the camera. The additional information provided by the polarization states means that fewer markers per image are needed and less precision is need when setting up the markers in the scenery.

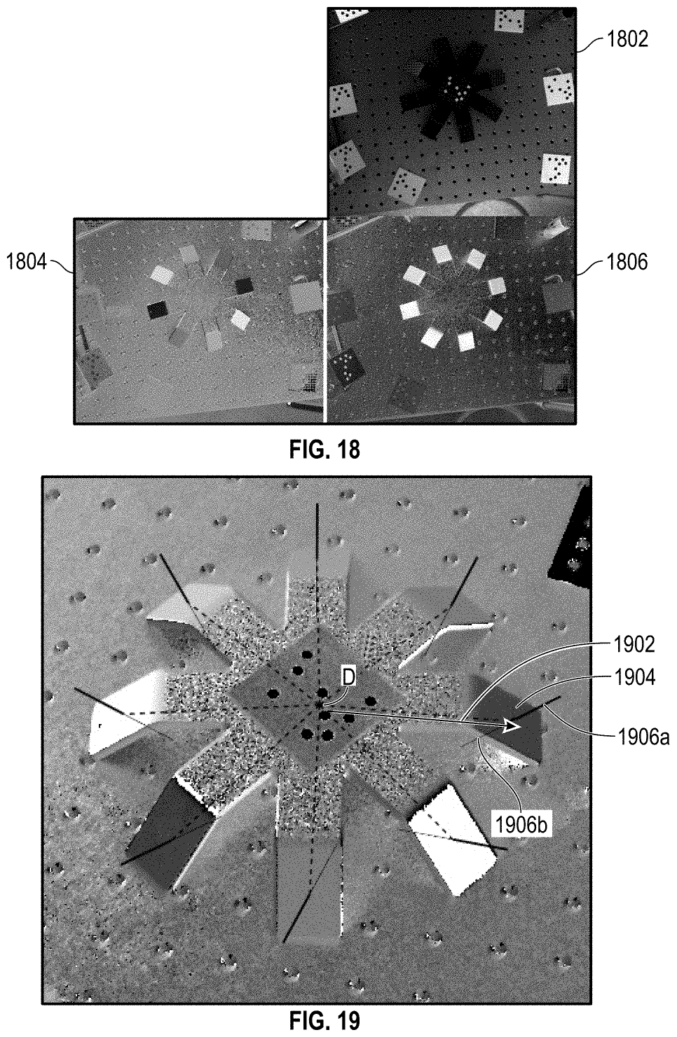

FIG. 18 shows the marker assembly 1700 of FIG. 17 as viewed via several cameras. Image 1802 shows a image of the marker assembly 1700 from a standard camera. The illumination of the scenery does not allow for a meaningful interpretation of the shape of the object. Polarization image 1804 shows the marker assembly 1700 displaying an angle of polarization of the facets of the marker assembly 1700. The polarization angle changes with the angular location of the facet along the marker assembly 1700. Polarization image 1806 shows a degree of polarization of each facet, which is significantly different from zero. Using the polarization images (1804, 1806), the geometric property of the marker assembly can be determined. The measured state of polarization of a facet depends not only on the geometry of the marker assembly 1700 but also on the relative position of the camera with respect to the marker assembly 1700. Thus, the polarization information can be used to obtain the relative rotation between the marker assembly 1700 and the camera.

A priori knowledge of the center D of the marker and of normal vectors of the facets is sufficient to constrain the position of the camera along a single line. The position of the camera along this line (i.e., the distance between the camera and the marker) can be estimated from the marker size as well as the sizes of other markers.\

The normal vectors of each facet within the coordinate system of the marker assembly 1700 can be determined during a previous calibration step. Each facet can be described by a normal vector \vec{nₖ}, where k is an index of the facet. When the marker assembly 1700 is rotated by a rotation matrix R̅ with respect to the camera, the normal vector is seen at the camera as:

$$\begin{matrix}\vec{{p}_{k}} = \overline{R} \vec{{n}_{k}} = \overline{{R}_{az ι muth , k}} \overline{{R}_{zen ι th , k}} ( \begin{matrix}0 \\ 0 \\ 1\end{matrix} ) \\ where & Eq . ( 12 ) \\ \overline{{R}_{az ι muth}} = ( \begin{matrix}cos α & - sin α & 0 \\ sin α & cos α & 0 \\ 0 & 0 & 1\end{matrix} ) & Eq . ( 13 )\end{matrix}$$

is the rotation matrix about the z-axis describing the azimuth angle which is measured by the camera along the viewing direction (which is set to be along the z-axis). Also

$$\overline{{R}_{az ι muth}} = ( \begin{matrix}cos α & 0 & sin α \\ 0 & 1 & 0 \\ - sin α & 0 & cos α\end{matrix} ) \qquad Eq . ( 14 )$$

is the rotation matrix about the y-axis describing the azimuth angle which is measured by the camera along the viewing direction (which is set to be along the z-axis). Thus, Eq. (12) can be rewritten as:

$$\vec{{n}_{k}} = {\overline{R}}^{- 1} \overline{{R}_{az ι muth , k}} \overline{{R}_{zen ι th , k}} ( \begin{matrix}0 \\ 0 \\ 1\end{matrix} ) \qquad Eq . ( 15 )$$

Since every Eqs. (13), (14) and (15) can be applied to each facet of the marker assembly 1700, the resulting system of equations is overdetermined and can be used to solve for the rotation matrix R as well as the zenith angle of each facet R̅_̅{̅a̅z̅i̅m̅u̅t̅h̅,̅k̅}̅.

FIG. 19 shows the polarization enhanced photogrammetric marker assembly 1700 of FIG. 17 with vectors illustrating how to resolve an ambiguity in the azimuth angle of a facet. It is noted that the azimuth angle of a facet determined using the Eqs. (13), (14) and (15) has an ambiguity of 180 degrees. In other words, the normal of the facet can be either pointing out of the facet or into the facet. This ambiguity can be resolved via the following method.

The two-dimensional center D of the marker assembly 1700 can be determined by locating the central disk of the marker is via known locations of the retroreflective markers on the marker assembly 1700. A radial vector 1902 can then be drawn from the center of the marker to the center of facet 1904. The facet 1904 includes a first normal vector 1906a that is pointing out of the facet 1904 and a second normal vector 1906b that is pointing into the facet 1904. The correct normal vector is the normal vector for which the dot product between the normal vector and the radial vector 1902 is a positive value.

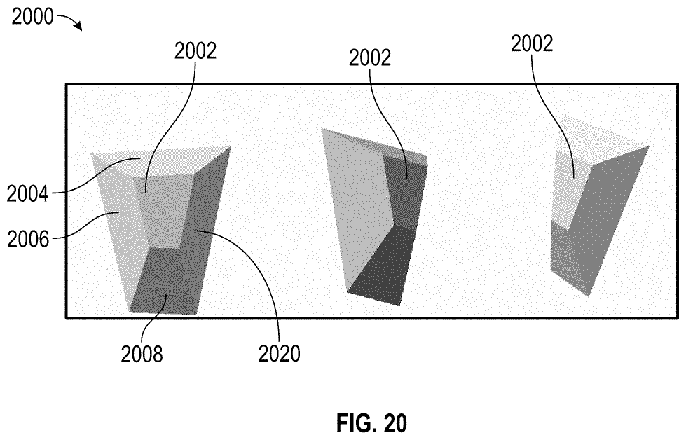

FIG. 20 shows various alternative three-dimensional markers that can be used in various embodiments. The alternative markers 2000 include polyhedrons with a first face 2002 that can include the various codes retroreflective surfaces disclosed herein and second faces 2004, 2006, 2008, 2020 that serve as the facets of the alternative markers 2000 that polarize light upon reflection.

As used herein, the term “module” or “unit” refers to an application specific integrated circuit (ASIC), a field programmable gate array (FPGA), an electronic circuit, an electronic computer processor (shared, dedicated, or group) and memory that executes one or more software or firmware programs, a hardware microcontroller, a combinational logic circuit, and/or other suitable components that provide the described functionality. When implemented in software, a module can be embodied in memory as a non-transitory machine-readable storage medium readable by a processing circuit and storing instructions for execution by the processing circuit for performing a method.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed is:

1. A method of determining an angular position of a retroreflective marker with respect to an imaging device, comprising:
measuring a first angle at the imaging device of a light projected between the retroreflective marker and the imaging device along a deviated optical path;
determining, at a processor, an angular deviation of the light from a straight-line path between the retroreflective marker and the imaging device; and
determining, at the processor, a second angle at the imaging device, the second angle indicative of the straight-line path based on the first angle and the angular deviation.

2. The method of claim 1, wherein a window between the retroreflective marker and the imaging device causes the deviated optical path, the window having a selected thickness and index of refraction.

3. The method of claim 2, further comprising:
determining a perpendicular distance between the retroreflective marker and the imaging device; and
determining the angular deviation based on the perpendicular distance, a thickness of the window, index of refraction of the window, and an angle of incidence of the light in air at the window.

4. The method of claim 1, further comprising obtaining a plurality of stereoscopic images of the retroreflective marker and determining a three-dimensional location of the retroreflective marker and the determined second angle.

5. The method of claim 4, wherein the retroreflective marker is circular, further comprising determining an orientation of the retroreflective marker with respect to the imaging device by measuring long and short axes of an elliptical image of the retroreflective marker.

6. The method of claim 5, further comprising recalculating the three-dimensional location of the retroreflective marker using the determined orientation.

7. The method of claim 4, further comprising:
determining a two-dimensional location of a marker within each of the plurality of stereoscopic images;
determining a three-dimensional location of the marker from the plurality of stereoscopic images;
determining a marker orientation within the plurality of stereoscopic images; and
correcting the three-dimensional location of the marker using the determined marker orientation.

8. A method of claim 1, wherein the retroreflective marker is in a form of one of: (i) a planar surface; (ii) a cylindrical surface; and (iii) a spherical surface.

9. A retroreflective marker assembly, comprising,
a retroreflective marker; and
a protective window, wherein light passes through the protective window to reflect from the retroreflective marker.

10. The retroreflective marker of claim 9 wherein the retroreflective marker is aligned on the same axis as a support to which it is affixed.

11. The retroreflective marker assembly of claim 9, wherein the retroreflective marker is placed between a planar base and the protective window.

12. The retroreflective marker assembly of claim 9, wherein the retroreflective marker includes a reflective film forming a cylindrical shell about a cylindrical base and the protective window is a cylindrical window surrounding the reflective film.

13. The retroreflective marker assembly of claim 9, wherein a retroreflective film is placed between a planar base and the protective window and where the window includes a mask which prevents the light from passing through portions of the protective window.

14. The retroreflective marker of claim 13 where the mask has an aperture and the retroreflective film can be seen through any part of the aperture.

15. The retroreflective marker of claim 14 where the mask has a circular shape.

16. The retroreflective marker of claim 14 wherein the mask is formed by physical vapor deposition.

17. The retroreflective marker of claim 13 wherein the mask is aligned on the same axis as a support to which it is affixed.

18. A retroreflective marker assembly, comprising:
a spherical base with a reflective coating and a mechanical element securing the reflective coating to the spherical base.

19. The retroreflective marker assembly of claim 18, wherein the reflective coating is formed by partially embedding reflective material in a liquid layer and subsequently curing the liquid layer to a final cured state.

20. The retroreflective marker assembly of claim 19, wherein the liquid layer is a partially cured powder coating.

21. A method of determining a parameter of an object, comprising:
placing a retroreflective marker assembly on a surface of the object, the retroreflective marker assembly comprising a support structure including one or more legs, each leg having a facet configured to polarize light upon reflection of the light from the facet, and a retroreflective marker located on a face of the support structure;
obtaining a polarization angle of light reflected from one of the facets at an imaging device;
determining an orientation of the retroreflective marker assembly with respect to the imaging device from a polarization of the light; and
determining the parameter of the surface from the determined orientation of the retroreflective marker assembly.

22. The method of claim 21, wherein the parameter is an orientation of a surface of the object.

23. The method of claim 21, further comprising determining a normal of one of the facets from the polarization of one of the facets.

24. The method of claim 22, further comprising resolving an ambiguity in the normal by determining a dot product of the normal with a radial line extending from a center of the retroreflective marker assembly to a center of the facet.

25. A retroreflective marker assembly, comprising:
a support structure including one or more legs, each leg having a facet configured to polarize light upon reflection of the light from the facet; and
a retroreflective marker located on a face of the support structure.

26. The retroreflective marker assembly of claim 25, wherein the support structure is a three-dimensional structure.

27. The retroreflective marker assembly of claim 26, wherein each of the one or more legs is bent away from a surface of the support structure having the retroreflective marker by a selected angle at a selected distance from a center of the retroreflective marker assembly.

28. The retroreflective marker assembly of claim 26, wherein the facet is on a portion of the leg that is bent away from the surface having the retroreflective marker.
